(19) United States
(12) Patent Application Publication
(10) Pub. No.: US 2026/0271069 A1
(43) Pub. Date: Sep. 10, 2026

(54) REPORTING TRAFFIC FEEDBACK IN A MULTI-STATION BLOCK ACKNOWLEDGE (MULTI-STA BA) FOR COORDINATED TIME DIVISION MULTIPLE ACCESS (CO-TDMA)

(71) Applicant: Cisco Technology, Inc., San Jose, CA (US)

(72) Inventors: Binita Gupta, San Diego, CA (US); Brian D. Hart, Sunnyvale, CA (US); Malcolm Muir Smith, Richardson, TX (US)

(21) Appl. No.: 19/557,793

(22) Filed: Mar. 5, 2026

Related U.S. Application Data
(60) Provisional application No. 63/767,373, filed on Mar. 5, 2025.
(60) Provisional application No. 63/971,204, filed on Jan. 29, 2026.

(51) Int. Cl. H04W 74/0816; H04L 5/00; H04W 28/02

(52) U.S. Cl. CPC H04W 74/0816; H04L 5/0053; H04W 28/0278

(57) ABSTRACT

Reporting traffic feedback in a Multi-Station Block Acknowledge (Multi-STA BA) for Coordinated Time Division Multiple Access (Co-TDMA) may be provided. A sharing Access Point (AP) may send a Buffer Status Report Pole (BSRP) trigger frame. The sharing AP may then receive, from at least one polled AP in a respective at least one Multi-Station Block Acknowledge (Multi-STA BA) in response to the BSRP trigger frame, traffic related feedback information. Next, the sharing AP may determine Transmission Opportunity (TxOP) sharing based on the traffic related feedback information.

### RELATED APPLICATION

Under provisions of 35 U.S.C. § 119(e), Applicant claims the benefit of U.S. Provisional Application No. 63/767,373, filed Mar. 5, 2025, which is incorporated herein by reference. Under provisions of 35 U.S.C. § 119(e), Applicant claims the benefit of U.S. Provisional Application No. 63/971,204, filed Jan. 29, 2026, which is incorporated herein by reference.

### TECHNICAL FIELD

The present disclosure relates generally to reporting traffic feedback in a Multi-Station Block Acknowledge (Multi-STA BA) for Coordinated Time Division Multiple Access (Co-TDMA).

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for reporting traffic feedback in a Multi-Station Block Acknowledge (Multi-STA BA) for Coordinated Time Division Multiple Access (Co-TDMA);

FIG. 2 is a flow chart of a method for reporting traffic feedback in a Multi-STA BA for Co-TDMA;

FIG. 3 illustrates setting a reserved bit in a Block Acknowledge (BA) control field in the Multi-STA BA;

FIG. 4 illustrates AP Buffer Status Report (BSR) feedback for Co-TDMA;

FIG. 5 illustrates AP Delay feedback for Co-TDMA;

FIG. 6 illustrates providing both BSR and delay feedbacks in the Multi-STA BA; and

FIG. 7 is a block diagram of a computing device.

### DETAILED DESCRIPTION

### Overview

Reporting traffic feedback in a Multi-Station Block Acknowledge (Multi-STA BA) for Coordinated Time Division Multiple Access (Co-TDMA) may be provided. A sharing Access Point (AP) may send a Buffer Status Report Pole (BSRP) trigger frame. The sharing AP may then receive, from at least one polled AP in a respective at least one Multi-Station Block Acknowledge (Multi-STA BA) in response to the BSRP trigger frame, traffic related feedback information. Next, the sharing AP may determine Transmission Opportunity (TxOP) sharing based on the traffic related feedback information.

Both the foregoing overview and the following example embodiments are examples and explanatory only and should not be considered to restrict the disclosure's scope, as described and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

For a Coordinated Time Division Multiple Access (Co-TDMA) feature, a sharing AP may share a portion of its Transmission Opportunities (TxOPs) with one or more polled APs (i.e., shared APs). The sharing AP may poll its neighboring co-channel APs for their intention to receive a portion of TxOPs from the sharing AP.

It may also be desirable for the sharing AP to get feedback on the traffic that is queued in the transmit queues at the polled APs, to use that information for determination of TxOP sharing with those polled APs. For example, if a polled AP indicates a high Buffer Status Report (BSR) queue size for high-Quality-of-Service (QoS) Traffic Identifiers (TIDs), then the sharing AP may decide to allocate a portion of its TxOPs to that polled AP. The queue size may be expressed as a time duration (queue duration) indicating the amount of time that is desired by the polled AP to serve its queued traffic (e.g. high QoS traffic) and may be indicated in some time granularity (e.g. 32/64/128 micro-seconds). The traffic information will help the sharing AP in determining with which polled AP(s) to share the portion of its TxOP.

During a polling phase, a Buffer Status Report Pole (BSRP) trigger frame or a BSRP NTB (Non-trigger based) trigger frame may be sent by the sharing AP to poll other polled APs for real-time status of traffic buffered so that the sharing AP may determine to share TxOPs with one or more of those polled APs. The polled APs may return a Multi-Station Block Acknowledge (Multi-STA BA) in response to the BSRP trigger frame or BSRP NTB trigger frame sent by the sharing AP. The polled APs may provide feedback information in the Multi-STA BA that may help the sharing AP to decide on TxOP sharing. Embodiments of the disclosure may provide traffic related feedback information from the polled APs to the sharing AP in the Multi-STA BA, including aggregated Buffer Status Report (BSR) information indicating queue size/queue duration and real-time delay feedback information considering TID queues across multiple associated Stations (STAs) at the polled AP Multi-Link Devices (MLDs).

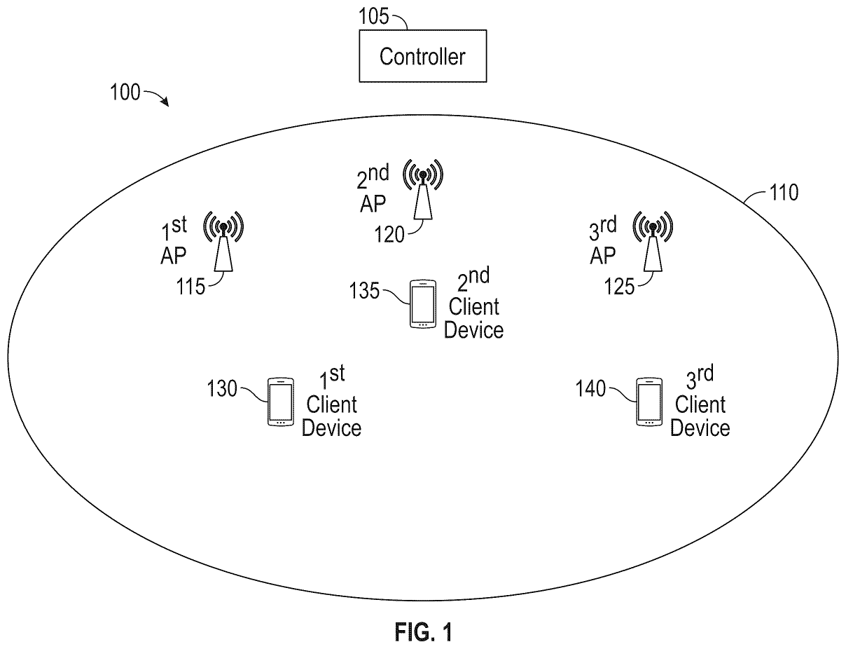

FIG. 1 shows an operating environment 100 for reporting traffic feedback in a Multi-STA BA for Co-TDMA. As shown in FIG. 1, operating environment 100 may comprise a controller 105 and a coverage environment 110. Coverage environment 110 may comprise, but is not limited to, a Wireless Local Area Network (WLAN) comprising a plurality of Access Points (APs) that may provide wireless network access (e.g., access to the WLAN for client devices). The plurality of APs may comprise a first AP 115, a second AP 120, a third AP 125. As described below, the plurality of APs may comprise any number of APs and is not limited to three.

The plurality of APs may provide wireless network access to a plurality of client devices (i.e., Station (STAs)) as they move within coverage environment 110. The plurality of client devices may comprise, but are not limited to, a first client device 130, a second client device 135, and a third client device 140. The plurality of client devices may comprise non-AP Multi-Link Devices (MLDs). Ones of the plurality of client devices may comprise, but are not limited to, a smart phone, a personal computer, a tablet device, a mobile device, a telephone, a remote control device, a set-top box, a digital video recorder, an Internet-of-Things (IoT) device, a network computer, a router, an Automated Transfer Vehicle (ATV), a drone, a vehicle, an autonomous vehicle, an Unmanned Aerial Vehicle (UAV), Virtual Reality (VR)/Augmented Reality (AR) devices, or other similar microcomputer-based device. Each of the plurality of APs may be compatible with specification standards such as, but not limited to, the Institute of Electrical and Electronics Engineers (IEEE) 802.11 specification standard.

The plurality of APs and the plurality of client devices may use Multi-Link Operation (MLO) where they simultaneously transmit and receive across different bands (or links) and channels by establishing two or more links to two or more AP radios. Accordingly, the plurality of APs and the plurality of client devices may comprise Multi-Link Devices (MLDs). These bands may comprise, but are not limited to the 2.4 GHz band, the 5 GHz band, the 6 GHz band, and the 60 GHz band. The two or more links on any given one of the plurality of client devices may be made with any one AP or with any combination of the APs.

Controller 105 may comprise a Wireless Local Area Network controller (WLC) and may provision and control coverage environment 110 (e.g., a WLAN). Controller 105 may allow first client device 130, second client device 135, and third client device 140 to join coverage environment 110. In some embodiments of the disclosure, controller 105 may be implemented by a Digital Network Architecture Center (DNAC) controller (i.e., a Software-Defined Network (SDN) controller) that may configure information for coverage environment 110 in order to report traffic feedback in a Multi-STA BA for Co-TDMA.

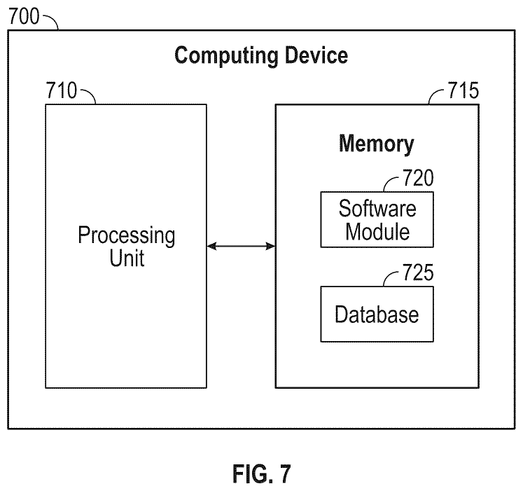

The elements described above of operating environment 100 (e.g., controller 105, first AP 115, second AP 120, third AP 125, first client device 130, second client device 135, or third client device 140) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 7, the elements of operating environment 100 may be practiced in a computing device 700.

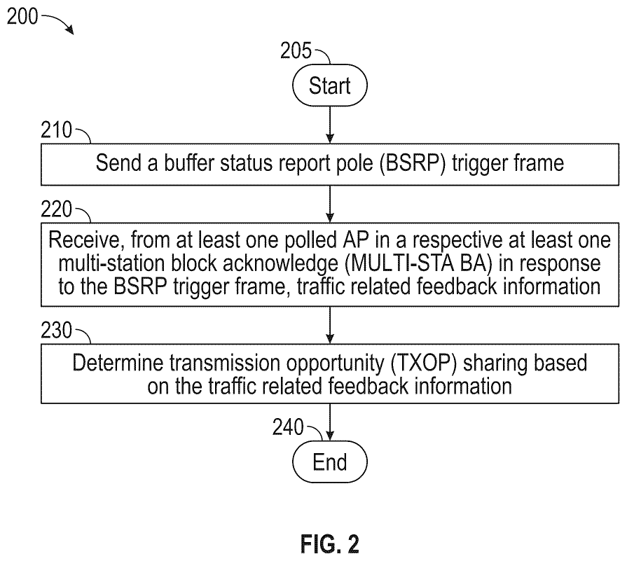

FIG. 2 is a flow chart setting forth the general stages involved in a method 200 consistent with embodiments of the disclosure for reporting traffic feedback in a Multi-STA BA for Co-TDMA. Method 200 may be implemented using a computing device 700 as described in more detail below with respect to FIG. 7. Computing device 700 may comprise a sharing AP and may be implemented by first AP 115. Second AP 120 and third AP 125 may comprise polled APs for example. Ways to implement the stages of method 200 will be described in greater detail below.

Method 200 may begin at starting block 205 and proceed to stage 210 where computing device 700 may send an (ICF) such as a Buffer Status Report Pole (BSRP) trigger frame or BSRP NTB trigger frame. For example, for Co-TDMA during a polling phase, the BSRP Trigger frame or BSRP NTB trigger frame may be sent by the sharing AP (e.g., first AP 115) to poll other APs (e.g., second AP 120 and third AP 125) for real-time status of traffic buffered, so that the sharing AP may determine to share TxOPs with one or more of those polled APs.

From stage 210, where computing device 700 sends the ICF, method 200 may advance to stage 220 where computing device 700 may receive, from at least one polled AP (e.g., second AP 120 or third AP 125) in a respective Initial Control Response (ICR) frame such as at least one Multi-Station Block Acknowledgement (Multi-STA BA) frame in response to the ICF, traffic related feedback information. For example, the polled APs may provide feedback information in the Multi-STA BA that may help the sharing AP to decide on TxOP sharing. A polled AP may provide its intention to receive or not receive TxOP allocation in the response, i.e., the ICR frame.

If the polled AP is interested in receiving TxOP from the sharing AP, it may provide feedback information on the queued traffic to the sharing AP. The feedback information that may be provided from the polled AP may, for example, include: i) AP BSR information providing status of buffered Tx queues and/or UL traffic to be served such as providing queue size/queue duration (based on DL and/or UL traffic); and ii) AP delay feedback based on an expiry deadline of Media Access Control (MAC) Protocol Data Units (MPDUs) in the Transmission (Tx) queues. The AP BSR information refers to information provided based on buffered Tx queues and/or UL traffic to be served at the polled AP, and may include queue size information which may be expressed as a queue duration (e.g. expressed in units of time) or as queue size in octets (as reported traditionally in BSR from STA to an AP) for the traffic that the polled AP wants to deliver (could include DL and/or UL traffic). The delay feedback information may include the expiry time for the traffic that the polled AP wants to deliver (could include DL and/or UL traffic). The sharing AP may use the BSR and delay feedback received from the polled APs to determine how much TxOP time to share with each of the polled APs (if any). The polled AP may use per Association Identifier (AID) Traffic Identifier (TID) information fields to provide both BSR and delay feedback information to the sharing AP in the Multi-STA BA frame.

### Providing Intention to Receive TxOp Sharing for Co-TDMA

Polled AP may provide an indication of its intention to receive TxOP from the sharing AP in the ICR frame such as in the Multi-STA BA frame by indicating this in a field. This indication can be provided as part of traffic feedback from the polled AP such as in the AP BSR feedback or in the delay feedback.

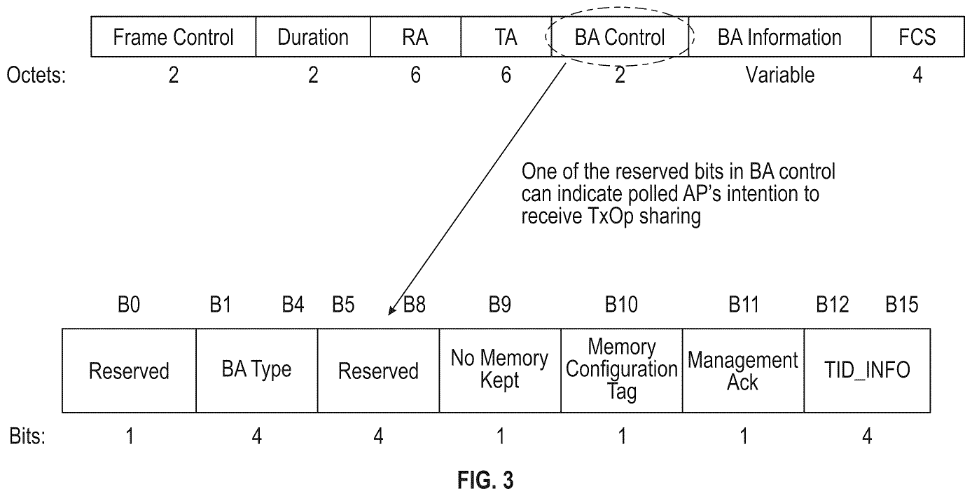

FIG. 3 illustrates setting a reserved bit in a Block Acknowledge (BA) control field in the Multi-STA BA. As shown in FIG. 3, embodiments may include this signaling for polled AP to provide its intention to receive or not receive TxOP allocation in the Multi-STA BA sent in response to BSRP Trigger frame. One of the Reserved bits in BA Control may indicate the polled AP's intention to receive TxOp sharing (e.g., set to 1 to indicate that polled AP is interested in receiving TxOP sharing else set to 0).

AP BSR feedback for Co-TDMA

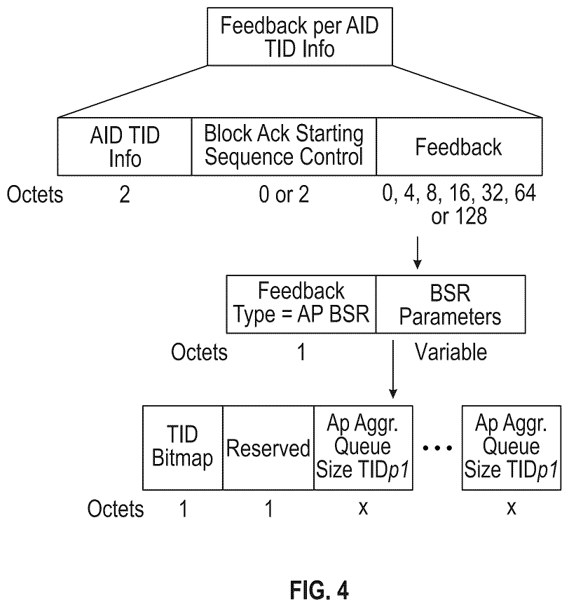

FIG. 4 illustrates AP BSR feedback for Co-TDMA. As shown in FIG. 4, a polled AP may provide its ‘AP BSR information’ in a Feedback Per AID TID field in the Multi-STA BA. The AP BSR information may be provided for Co-TDMA needs to provide aggregate queue size/queue duration per TID across multiple associated STAs at the AP MLD. The queue size/queue duration may be indicated in units of time or queue size in octets, indicating needs for buffered DL traffic or UL traffic that polled AP wants to be served. This may be different than the BSR information provided from a non-AP STA or from an AP to a non-AP STA (e.g., in roaming transition case), because that BSR information may only include queue size information for STA specific TID queues. However, for the Co-TDMA case, the AP BSR information provided by the polled AP is based on the aggregated DL buffered traffic and/or UL traffic to be served across multiple STAs associated with the polled AP.

The AP BSR information provided for Co-TDMA from a polled AP to the Sharing AP may include aggregated queue size/queue duration for a TID across multiple associated STAs at the polled AP MLD. A polled AP may determine which TID queues (from associated STAs or associated non-AP MLDs) it takes into account to provide aggregated BSR information to the sharing AP (or AP MLD). For example, the polled AP may account for TID queues for all associated STAs in its aggregated BSR information.

Embodiments of the disclosure may provide that larger queue sizes/queue duration may be supported for AP BSR information reporting between APs (e.g., as compared to BSR reporting between AP and STAs), to account for reporting aggregated queue size/queue duration across multiple STAs. The Multi-STA BA may be defined to accommodate a larger queue size/queue duration for AP to AP BSR reporting, and the same format may be used when a non-AP STA is reporting BSR in the Multi-STA BA. In one embodiment, a TID Bitmap may be included to indicate the set of TIDs for which an aggregated queue size/queue duration is provided as shown below in FIG. 4. In an alternate embodiment, a list of (e.g., TID, AP aggregated queue size/queue duration) tuples may be included. However, this may cause a larger overhead than including a TID Bitmap.

### AP Delay Feedback for Co-TDMA

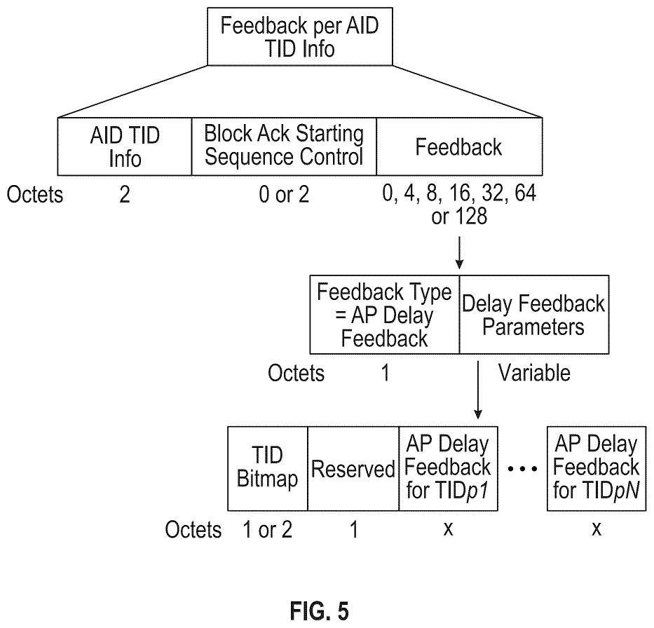

FIG. 5 illustrates AP Delay feedback for Co-TDMA. As shown in FIG. 4, a polled AP may provide its real-time delay feedback information in a Feedback Per AID TID field in the Multi-STA BA to the sharing AP. The delay feedback information may be provided per TID (or per AC) and may provide delay based on expiry deadline of MPDUs that remain in the Tx queues for the corresponding TID (across one or more associated STAs) at the polled AP. For example, there may be two options for how real-time delay feedback information may be provided based on MPDUs remaining in the Tx queues. A first option may be to provide delta delay to expiry deadline for MPDUs in Tx queues for the TIDs (across one or more associated STAs). For a given TID, this may provide delta delay time to the expiry deadline for earliest MPDU expiry in the Tx queues for that TID (across one or more associated STAs). A second option may be to provide Timing Synchronization Function (TSF) time of expiry deadline for MPDUs in Tx queues for the TIDs. For a given TID, this may provide TSF time representing earliest expiry deadline for MPDUs in that TID queues (across one or more associated STAs). In some embodiments, the delay feedback information provided by the polled AP may also take into account the real-time delay information for the UL traffic that needs to be served by the polled AP across one or more associated STAs (or non-AP MLDs). For example, the delay feedback information may report a delta delay time (as in the first option above) based on the DL buffered traffic and/or earliest expiry of UL traffic per UL traffic periodic service interval and delay bound.

A polled AP may provide delay feedback using any of the options above. For Co-TDMA, the polled AP may need to determine the delay feedback based on the earliest expiry deadline of MPDUs queued across multiple TID queues for multiple/all associated STAs of that AP MLD. This may be different than the delay feedback information provided from a non-AP STA, because in the case of Co-TDMA the delay feedback may need to account for MPDUs in multiple queues for the same TID, across multiple associated STAs.

In the Feedback Per AID TID Information field for delay feedback, the Feedback field may indicate an ‘AP Delay Feedback’ type. It may include a TID Bitmap indicating a set of TIDs for which delay feedback information is included. The ‘AP Delay Feedback for TIDp1 may be provided considering delay feedback from multiple Tx queues for TIDp1 across multiple associated STAs/non-AP MLDs. For example, for TID 4, ‘AP Delay Feedback for TID4’ field may carry a delay feedback value computed based on earliest expiry deadline across MPDUs in TID4 queues across multiple associated STAs. The AP may determine which TIDx queues (from one or more STAs) it takes into account when determining value for AP delay feedback for TIDx. Alternatively, the AP may take into account all TIDx queues across all associated STAs when determining value for AP delay feedback for TIDx. Alternative encoding of AP delay feedback may be possible in the Multi-STA BA frame. Note that if delay feedback is provided as a TSF time for expiry deadline, then the AP may provide a ‘Reference Link ID’ for the link used for TSF time reference. In one option, a list of (TID, delay feedback) tuples may be included, providing delay feedback per TID. However, this may cause a larger overhead than including a TID Bitmap.

The Multi-STA BA may also carry delay feedback independent of Co-TDMA and not limited to use only by a polled AP. For example, a non-STA may provide its delay feedback to its serving AP in a Multi-STA BA in cases where it intends to provide real-time delay information for better Uplink (UL) triggering by the AP. For this case a different ‘STA Delay Feedback’ type may be defined (different from ‘AP Delay Feedback’ provided in case of Co-TDMA), because the two types may provide a different set of information (per-STA vs. across multiple STAs). Alternatively, same ‘Delay Feedback’ type may be used for both cases: i) when a STA provides its delay feedback; and ii) when an AP provides its delay feedback (for Co-TDMA), and based on the context the delay feedback content may be interpreted accordingly.

### Providing Both BSR and Delay Feedbacks in Multi-STA BA

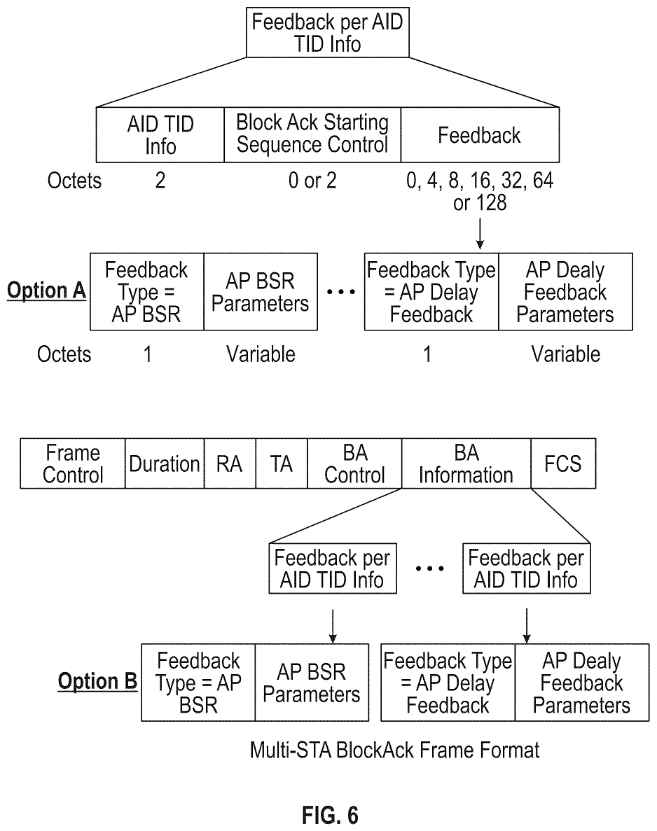

FIG. 6 illustrates providing both BSR and delay feedbacks in the Multi-STA BA. As shown FIG. 6, a polled AP in Co-TDMA may report both BSR and delay feedback information to the sharing AP in Multi-STA BA by including both sets of feedback information. The AP may use Per AID TID Info field(s) to provide both BSR and delay feedback information. The following example options may be used. In a first example option, the BSR and delay feedback may be included in the same generic ‘Feedback Per AID TID Info’ field with Feedback Type identifying each type of feedback information. With this first example option, it is possible to carry multiple feedback information in the same Per AID TID information field using a set of Type, Value, Length (TLVs) or a set of Type, Value (TV), one for each feedback type. Alternatively, a Presence Indication Bitmap may be used to indicate the presence of different feedback types. In a second example option, the BSR and Delay Feedback may be provided in separate ‘Feedback Per AID TID Info’ fields with different ‘Feedback Type’ indicated for each. In a third example option, the BSR and Delay Feedback may be provided in two different Per AID TID Info fields defined for BSR and Delay Feedback (with different TID values used to distinguish the fields). In a fourth example option, the BSR and Delay Feedback information may be provided in the same feedback type, e.g. a ‘Co-TDMA feedback’ type where the AP BSR information (e.g. queue size/queue duration information) and delay feedback information is provided on a per TID or per AC basis.

Similar schemes may be used by a STA to report BSR and/or Delay Feedback in a Multi-STA BA, (other than the Co-TDMA case describe above). Accordingly, a STA may provide BSR and/or Delay Feedback in a Multi-STA BA Initial Control Response (ICR) sent in response to an Initial Control Frame (ICF) (e.g. a Buffer Status Report Poll (BSRP) Trigger frame), or a STA may provide BSR and/or delay feedback in a Multi-STA BA frame (or another control frame) that it may send unsolicited to an AP.

Once computing device 700 receives the traffic related feedback information in stage 220, method 200 may continue to stage 230 where computing device 700 may determine TxOP sharing based on the traffic related feedback information. For example, the sharing AP (e.g., first AP 115) may use the BSR, delay feedback, or both received from the polled APs (e.g., second AP 120 and third AP 125) to determine how much TxOP time to share with each of the polled APs (if any). The polled AP may use Per AID TID information fields to provide both BSR and delay feedback information to the sharing AP in the Multi-STA BA. Once computing device 700 determines TxOP sharing based on the traffic related feedback information in stage 230, method 200 may then end at stage 240.

FIG. 7 shows computing device 700. As shown in FIG. 7, computing device 700 may include a processing unit 710 and a memory unit 715. Memory unit 715 may include a software module 720 and a database 725. While executing on processing unit 710, software module 720 may perform, for example, processes for reporting traffic feedback in a Multi-STA BA for Co-TDMA as described above with respect to FIG. 2. Computing device 700, for example, may provide an operating environment for controller 105, first AP 115, second AP 120, third AP 125, first client device 130, second client device 135, or third client device 140. Controller 105, first AP 115, second AP 120, third AP 125, first client device 130, second client device 135, or third client device 140 may operate in other environments and are not limited to computing device 700.

Computing device 700 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 700 may comprise any computer operating environment, such as hand-held devices, multiprocessor systems, microprocessor-based or programmable sender electronic devices, minicomputers, mainframe computers, and the like. Computing device 700 may also be practiced in distributed computing environments where tasks are performed by remote processing devices. The aforementioned systems and devices are examples, and computing device 700 may comprise other systems or devices.

### Rich Information in an ICF for Multi-Access Point Coordination (MAPC)

Within a feedback field, which may be 32 bits in length, B0 may be already assigned as TxOP sharing. B1 (or another bit in the field) may indicate if other bits in the field are vendor specified or IEEE defined. If signaled as vendor specified, then the remaining bits may contain vendor specified content. If we are limited, for example, to a 32-bit feedback field, then there may be 30 bits left (or more, if we allow a 32/64/128 feedback field). The following tables may provide example formats for ICFs.

### Rich Information for Multiple TIDs

TABLE 1

| Field name | Notes | Number of bits |
|---|---|---|
| TID List Info | Option A: 16 TID records are always present. | Option A: 0 |
| | Option B: 8 TID records are always present. | Option B: 0 |
| | Option C: 1 bit to indicate whether 8 or | Option C: 1 |
| | 16 TID records are present. | Option D: 16 |
| | Option D: 16 bit bitmap to indicate which | Option E: 8 |
| | TID records are present. | Option F: 9 or 17 (not preferred) |
| | Option E: 8 bit bitmap to indicate which | Bonus G: +0 bits |
| | TID records are present. | Bonus H: +1 bit |
| | Option F: 1 bit to indicate whether an 8 or | |
| | 16 bit bitmap is present, then 8 or 16 bits | |
| | to indicate which TID records are present. | |
| | Bonus G: add an always-present | |
| | “All/Other” record | |
| | Bonus H: add an optional “All/Other” | |
| | record (i.e., with its own presence bit in | |
| | the bitmap) | |
| | In all cases, the number N of TID records | |
| | is identified by the signaling | |

For each of the N TID records

| | | |
|---|---|---|
| Expiry Is Valid | 0 (Expiry field is reserved; e.g. data does | Option a: 1 |
| | not expire or expiry time is at least | Option b: 0 (Expiry field is always valid) |
| | approx. 63 TU ahead), 1 (Expiry field is | |
| | valid) | |
| Expiry | Option 1: TSF[15:9] | Option 1: 7 (up to 63.5 TU in the future) |
| | Option 2: TSF[15:10] | Option 2: 6 (up to 63 TU in the future) |
| Queue Duration | Units of 64 usec | Option 1: 8 (up to 16.32 msec) |
| | | Option 2: 6 (up to 4.16 msec) |
| Total (examples) | | Option Ea1 with 1/2/3/4/5/6/7/8 TIDs: |
| | | 8 + (1/2/3/4/5/6/7/8)*16 = |
| | | 24/40/56/72/88/104/120/136 bits |
| | | Option Ea2 with 1/2/3/4/5/6/7/8 TIDs: |
| | | 8 + (1/2/3/4/5/6/7/8)*13 = |
| | | 21/34/47/60/73/86/99/112 bits |
| | | Option Eb2 with 1/2/3/4/5/6/7/8 TIDs: |
| | | 8 + (1/2/3/4/5/6/7/8)*12 = |
| | | 20/32/44/56/68/80/92/104 bits |
| | | All of these are +1 bit with Bonus H. For |
| | | instance, option Ea2 + H allows up to: |
| | | 4 TID records within 61 bits, or |
| | | 3 TID records and 1 “other” |
| | | TID record within 61 bits |
| | | . . . which fits within 64 bits. |

With respect to Table 1, the max value of Queue Duration indicates “max value or more”. The TSF may be of the transmitting AP; if so, the receiving AP is responsible for applying a correction to the local TSF (e.g., subtract an offset determined from beacon sniffing). If affiliated APs start at a time such that bits 9-16 or 10-16 of the TSFs of the affiliated APs of an AP MLD are the same, or the same almost always, then the transmitter can tag a to-be-transmitted MSDU with a single expiry TSF that is valid whichever link(s) that the MSDU is actually transmitted on. The length could be fixed at 64 bits (with a moderate implied limit on the number of TID records that can be sent) or 128 bits (with a loose implied limit on the number of TID records that can be sent) or 256 bits (no limit), or leave the length flexible (32/64/128/256 bits) for APs that wish to report less information. However, a flexible length may be harder to process and also harder to the transmitting AP to determine the NAV duration to allocate. These field sizes shown as preferred examples in table 1 could be increased or decreased with corresponding impacts on behavior.

BSR-Like Information with Expiry Information

TABLE 2

| | | | Number of | Number of | |
|---|---|---|---|---|---|
| | | Number of | bits for | bits for | Number of |
| | | bits for | options | option | bits for |
| Field name | Notes | option A | B/C | D/E/F | option G |
| TID Indication For | Option A: TID (TC) bitmap | 8 | 6 | 3 | 3 |
| Queue Duration | Option B: ACI bitmap + Delta TID | | | | |
| Other | per BSR | | | | |
| | Option C: 3 bit Lo TID and 3 bit Hi | | | | |
| | TID, and thereby indicates all TIDs | | | | |
| | in the range Lo . . . Hi inclusive (TBD: | | | | |
| | including/excluding TID High?) | | | | |
| | Option D: Lo TID, and thereby | | | | |
| | includes all TIDs up to TID High-1 | | | | |
| | (Lo TID must be < Hi TID) | | | | |
| | Option E: Lo TID and thereby | | | | |
| | includes all higher TIDs but | | | | |
| | excluding TID High | | | | |
| | Option F: Other TID (indicates itself | | | | |
| | only) | | | | |
| | Option G: Option E or F according | | | | |
| | to Selector | | | | |
| Selector | Option E vs Option F | 0 | 0 | 0 | 1 |
| TID High | For Queue Duration High | 3 | 3 | 3 | 3 |
| Expiry Is Valid | 0 (Expiry fields are reserved; e.g. | 1 | 1 | 1 | 1 |
| | data does not expire or expiry time | | | | |
| | is at least approx. 63.5 TU ahead), 1 | | | | |
| | (Expiry fields are valid) | | | | |
| Expiry High | Option A/D/E/F/G: TSF[14:10] | 5 (up to | 7 (up to | 5 (up to | 5 (up to |
| | Options B/C: TSF[15:9] | 31 TU in | 63.5 TU in | 31 TU in | 31 TU in |
| | | the future) | the future) | the future) | the future) |
| Expiry Other | TSF[14:10] | 0 | 0 | 5 (up to | 5 (up to |
| | | | | 31 TU in | 31 TU in |
| | | | | the future) | the future) |
| Scaling Factor | Option A-F: Common “exponent” | 1 | 1 | 1 | 0 |
| | (64 or 256 usec) | | | | |
| | Option G: N/A | | | | |
| Queue Duration | Option A-F: Mantissa (with | 6 | 6 | 6 | 6 |
| High | exponent, enables 64 usec | | | | |
| | resolution up to 4.032 msec then | | | | |
| | 256 usec resolution up to 16.128 | | | | |
| | msec | | | | |
| | Option G: Units of 64 usec, up to | | | | |
| | 4.032 msec | | | | |
| Queue Duration | Mantissa (ditto) | 6 | 6 | 6 | 6 |
| Other | | | | | |
| Total | | 30 | 30 | 30 | 30 |

With respect to Table 2, the max values of Queue Duration X+Scaling Factor indicate “max value or more”. The TSF may be of transmitting AP; if so, the receiving AP is responsible for applying a correction to the local TSF (e.g., subtract an offset determined from beacon sniffing). If affiliated APs start at a time such that bits 9-16 or 10-16 of the TSFs of the affiliated APs of an AP MLD are the same, or the same almost always, then the transmitter can tag a to-be-transmitted MSDU with a single expiry TSF that is valid whichever link(s) that the MSDU is actually transmitted on. These field sizes shown as preferred examples in table 2 could be increased or decreased, with corresponding impacts on behavior (e.g., if the Expiry Is Valid field were omitted, then the Expiry field would always be validly populated).

BSR-Like Information without Expiry Information

TABLE 3

| | | | Number of | Number of | |
|---|---|---|---|---|---|
| | | Number of | bits for | bits for | Number of |
| | | bits for | options | option | bits for |
| Field name | Notes | option A | B/C | D/E/F | option G |
| TID Indication For | Option A: TID (TC) bitmap | 8 | 6 | 3 | 3 |
| Queue Duration | Option B: ACI bitmap + Delta TID | | | | |
| Other | per BSR | | | | |
| | Option C: 3 bit Lo TID and 3 bit Hi | | | | |
| | TID, and thereby indicates all TIDs | | | | |
| | in the range Lo . . . Hi inclusive (TBD: | | | | |
| | including/excluding TID High?) | | | | |
| | Option D: Lo TID, and thereby | | | | |
| | includes all TIDs up to TID High-1 | | | | |
| | (Lo TID must be < Hi TID) | | | | |
| | Option E: Lo TID and thereby | | | | |
| | includes all higher TIDs but | | | | |
| | excluding TID High | | | | |
| | Option F: Other TID (indicates itself | | | | |
| | only) | | | | |
| | Option G: Option E or F according | | | | |
| | to Selector | | | | |
| Selector | Option E vs Option F | 0 | 0 | 0 | 1 |
| TID High | For Queue Duration High | 3 | 3 | 3 | 3 |
| Scaling Factor | Common “exponent” (64 or 256 usec) | 1 | 1 | 1 | 1 |
| Queue Duration | Mantissa (with exponent, enables | 6 | 6 | 6 | 6 |
| High | 64 usec resolution up to 4.032 | | | | |
| | msec then 256 usec resolution up | | | | |
| | to 16.128 msec | | | | |
| Queue Duration | Mantissa (ditto) | 6 | 6 | 6 | 6 |
| Other | | | | | |
| Reserved | | 6 | 8 | 11 | 10 |
| Total | | 30 | 30 | 30 | 30 |

With respect to Table 3, the max values of Queue Duration X+Scaling Factor indicate “max value or more”. The TSF may be of the transmitting AP; if so the receiving AP is responsible for applying a correction to the local TSF (e.g., subtract an offset determined from beacon sniffing). If affiliated APs start at a time such that bits 9-16 or 10-16 of the TSFs of the affiliated APs of an AP MLD are the same, or the same almost always, then the transmitter can tag a to-be-transmitted MSDU with a single expiry TSF that is valid whichever link(s) that the MSDU is actually transmitted on. These field sizes could be increased or decreased, with corresponding impacts on behavior (e.g., if the Expiry Is Valid field were omitted, then the Expiry field would always be validly populated).

BSR-“High”-Like Information without Expiry Information or “Other” Medium Time

TABLE 4

| | | Number of bits |
|---|---|---|
| Field name | Notes | for option A |
| TID Indication For | TID (TC) bitmap | 8 |
| Queue Duration | // Which TIDs have buffered | |
| Other | traffic, but no indication | |
| | of how much medium time. | |
| TID High | For Queue Duration High | 3 |
| Queue Duration | Units of 64 usec | 8 (up to 16.32 |
| High | | msec) |
| Reserved | | 11 |
| Total | | 30 |

With respect to Table 4, max values of Queue Duration X+Scaling Factor indicate “max value or more”. TSF may be of transmitting AP; if so, receiving AP is responsible for applying a correction to the local TSF (e.g., subtract an offset determined from beacon sniffing). If affiliated APs start at a time such that bits 9-16 or 10-16 of the TSFs of the affiliated APs of an AP MLD are the same, or the same almost always, then the transmitter can tag a to-be-transmitted MSDU with a single expiry TSF that is valid whichever link(s) that the MSDU is actually transmitted on. These field sizes could be increased or decreased, with corresponding impacts on behavior (e.g., if the Expiry Is Valid field were omitted, then the Expiry field would always be validly populated).

### Basic (TID Bitmap Only)

TABLE 5

| | | Number of bits |
|---|---|---|
| Field name | Notes | for option A |
| TID Indication For | TID (TC) bitmap | 8 |
| Queue Duration | // Which TIDs have buffered | |
| Other | traffic, but no indication | |
| | of how much medium time. | |
| Reserved | | 22 |
| Total | | 30 |

With respect to Table 5, these field sizes could be increased or decreased, with corresponding impacts on behavior (e.g., if the 16 bits of TID Indication is provided then this applies to both traffic categories and traffic streams; or if 4 bits are provided then these correspond to high-QoS TIDs.).

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 700 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
sending, by a sharing Access Point (AP), one of a Buffer Status Report Pole (BSRP) trigger frame and a BSRP Non-Trigger Based (NTB) trigger frame;
receiving, by the sharing AP from at least one polled AP in a respective at least one Multi-Station Block Acknowledgement (Multi-STA BA) frame in response to the one of the BSRP trigger frame and the BSRP NTB trigger frame, traffic related feedback information; and
determining, by the sharing AP, Transmission Opportunity (TxOP) sharing based on the traffic related feedback information.

2. The method of claim 1, wherein the Multi-STA BA indicates that the at least one polled AP wants to receive TxOP sharing.

3. The method of claim 1, wherein the traffic related feedback information comprises Buffer Status Report (BSR) information providing status of buffered Transmission (Tx) queues of the at least one polled AP.

4. The method of claim 3, wherein the BSR information is provided in a feedback per Association Identifier (AID) Traffic Identifier (TID) information field in the Multi-STA BA.

5. The method of claim 4, wherein the BSR information includes queue size information for one or more TIDs, wherein the queue size information indicates one of the queue size in octets of queued traffic to be served at the polled AP and a queue duration that indicates time duration which is requested for serving the queued traffic at the polled AP.

6. The method of claim 4, wherein the BSR information is provided based on one of buffered traffic in Down Link (DL) transmit queues and Uplink (UL) traffic to be served for associated STAs at the polled AP.

7. The method of claim 1, wherein the traffic related feedback information comprises delay feedback information based on expiry deadline of Media Access Control (MAC) Protocol Data Units (MPDUs) in Transmission (Tx) queues of the at least one polled AP.

8. The method of claim 7, wherein the delay feedback information is provided in a feedback per Association Identifier (AID) Traffic Identifier (TID) information field in the Multi-STA BA.

9. The method of claim 7, wherein the delay feedback information is provided for one or more TIDs.

10. The method of claim 7, wherein the delay feedback information is provided based on one of buffered traffic in Downlink (DL) transmit queues and Uplink (UL) traffic to be served for associated STAs at the polled AP.

11. The method of claim 1, wherein the traffic related feedback information comprises Buffer Status Report (BSR) information providing status of buffered Transmission (Tx) queues of the at least one polled AP and delay feedback information based on expiry deadline of Media Access Control (MAC) Protocol Data Units (MPDUs) in the Transmission (Tx) queues of the at least one polled AP.

12. The method of claim 11, wherein the BSR information and the delay feedback information are provided in a feedback per Association Identifier (AID) Traffic Identifier (TID) information field in the Multi-STA BA.

13. A system comprising:
a memory storage; and
a processing unit disposed in a sharing Access Point (AP) and coupled to the memory storage, wherein the processing unit is operative to:
send one of a Buffer Status Report Pole (BSRP) trigger frame and a BSRP Non-Trigger Based (NTB) trigger frame;
receive, from at least one polled AP in a respective at least one Multi-Station Block Acknowledgement (Multi-STA BA) frame in response to the one of the BSRP trigger frame and the BSRP NTB trigger frame, traffic related feedback information; and
determine Transmission Opportunity (TxOP) sharing based on the traffic related feedback information.

14. The system of claim 13, wherein the Multi-STA BA indicates that the at least one polled AP wants to receive TxOP sharing.

15. The system of claim 13, wherein the traffic related feedback information comprises Buffer Status Report (BSR) information providing status of buffered Transmission (Tx) queues of the at least one polled AP.

16. The system of claim 15, wherein the BSR information is provided in a feedback per Association Identifier (AID) Traffic Identifier (TID) information field in the Multi-STA BA.

17. A non-transitory computer-readable medium that stores a set of instructions which when executed perform a method executed by the set of instructions comprising:
sending, by a sharing Access Point (AP), one of a Buffer Status Report Pole (BSRP) trigger frame and a BSRP Non-Trigger Based (NTB) trigger frame;
receiving, by the sharing AP from at least one polled AP in a respective at least one Multi-Station Block Acknowledgement (Multi-STA BA) frame in response to the one of the BSRP trigger frame and the BSRP NTB trigger frame, traffic related feedback information; and
determining, by the sharing AP, Transmission Opportunity (TxOP) sharing based on the traffic related feedback information.

18. The non-transitory computer-readable medium of claim 17, wherein the Multi-STA BA indicates that the at least one polled AP wants to receive TxOP sharing.

19. The non-transitory computer-readable medium of claim 17, wherein the traffic related feedback information comprises Buffer Status Report (BSR) information providing status of buffered Transmission (Tx) queues of the at least one polled AP.

20. The non-transitory computer-readable medium of claim 17, wherein the BSR information is provided in a feedback per Association Identifier (AID) Traffic Identifier (TID) information field in the Multi-STA BA.
